(19) United States
(12) Patent Application Publication
(10) Pub. No.: US 2015/0313412 A1
(43) Pub. Date: Nov. 5, 2015

(54) Food Product Cooking Basket

(71) Applicant: Prince Castle, LLC., Carol Stream, IL (US)

(72) Inventors: Christine S. Laub, Roselle, IL (US); Kyle T. Kestner, Schaumburg, IL (US); Scott R. Hammac, Joliet, IL (US); Loren Veltrop, Chicago, IL (US)

(73) Assignee: PRINCE CASTLE, LLC., Carol Stream, IL (US)

(21) Appl. No.: 14/267,406

(22) Filed: May 1, 2014

(51) Int. Cl. A47J 37/12; A47B 55/02

(52) U.S. Cl. CPC A47J 37/1295; A47B 55/02

(57) ABSTRACT

Generally horizontal food-supporting shelves vertically stacked in a space between wire side walls are movable from horizontal food-supporting positions to generally vertical loading positions to allow food products to be loaded onto a given shelf without interference from any shelf above the given shelf. At least one shelf is removable. The removable shelf has a spring steel wire at one side of the shelf, one end of which is attached to transverse rods forming the shelf. The opposite end of the spring steel wire is not attached but able to deflect into and out of a hook formed at one end of a rod at the back of the shelf. The same end of the spring steel wire has a projection that provides a pivot pin to the removable shelf.

### BACKGROUND

Various types of containers or baskets are used for holding food products during cooking. For instance, wire form baskets are used for holding various types of food products, such as potatoes, pies, meat products and the like in a deep frying apparatus. Typically, the baskets are loaded with the bulk food products and are lowered into a reservoir of hot frying oil. In preparing French-fried potatoes, for instance, a typical wire form basket simply is of an open-top structure, rectangular in configuration, and includes upright side walls about a bottom wall. One or more handles may be provided for manually or automatically lowering the wire form basket and food products into the hot frying oil.

Another type of food product prepared by deep frying apparatus is chicken filets. If the filets simply are deposited in a bulk-type basket as described above for potato products, the filets tend to curl-up during cooking. Such a product not only appears to be smaller in size, but the curled-up filets are difficult to use in sandwich products, such as in high volume restaurants or similar establishments. Even if the filets are arranged on a flat support, the filets still have a tendency to curl-up during cooking.

The present invention is directed to solving these various problems, and providing a basket for holding food products in a unique movable shelf system, including a shelf that can be installed and removed “in the field” without requiring tools or special equipment.

### BRIEF DESCRIPTION OF THE FIGURES

FIG. 1 is a front/top perspective view of a wire form basket incorporating the concepts of the invention;

FIG. 2 is a rear/bottom perspective view of the basket;

FIG. 3 is a front elevation view of the basket;

FIG. 4 is a side elevation view of the basket;

FIG. 5 is a perspective view of the wire form frame of the basket;

FIG. 6 is a front elevation view of the frame;

FIG. 7 is a side elevation view of the frame;

FIG. 8 is a perspective view of one the shelves of the basket;

FIG. 9 is a front elevation view of the shelf;

FIG. 10 is a side elevation view of the shelf;

FIG. 11 is a side elevation view of the basket, with the bottom shelf in its horizontal food-supporting position and the remaining shelves pivoted to their vertical loading positions;

FIG. 12 is a perspective view of a removable shelf, one side of which is a spring-steel wire;

FIG. 13 is a perspective view of the shelf shown in FIG. 12 with the spring-steel wire in a locked position;

FIG. 14 is a perspective view of an alternate embodiment of a removable shelf, both sides of which are made of a spring-steel wire;

FIG. 15 is a perspective view of the shelf shown in FIG. 14 with the spring-steel wires in a locked position;

FIG. 16 is a perspective view of the food cooking basket 12 of FIG. 1, the top shelf 1200 of which is made field-replaceable using the shelf shown in FIGS. 12 and 13; and

FIG. 17 is a perspective view of the food cooking basket 12 of FIG. 1, the top shelf 1400 of which is made field-replaceable using the shelf shown in FIGS. 14 and 15.

### DETAILED DESCRIPTION

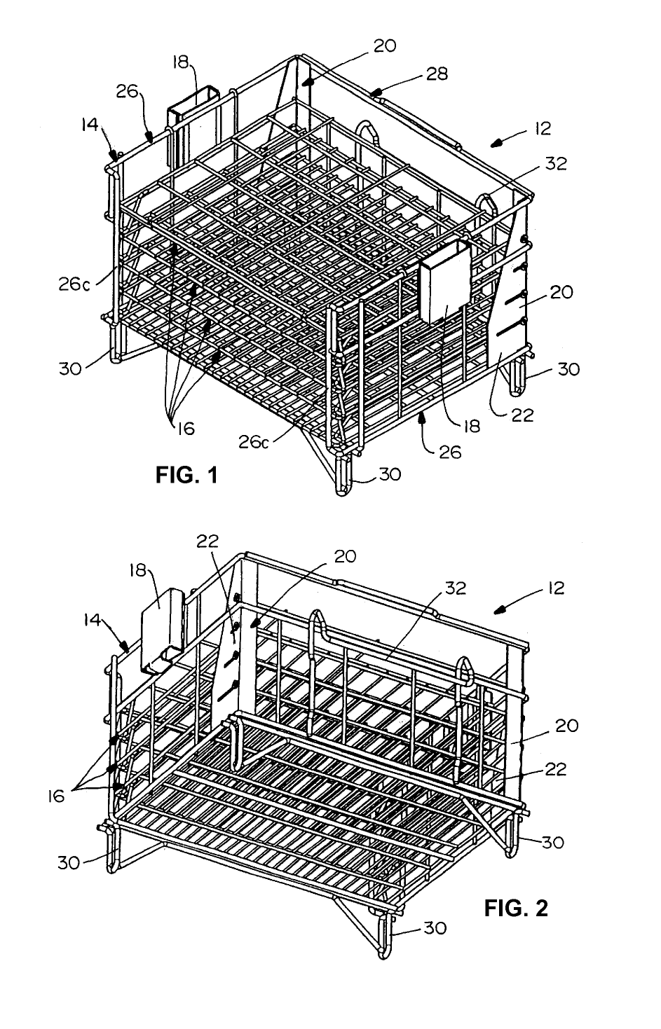

Referring to the drawings in greater detail, and first to FIGS. 1-4, the invention is embodied in a wire form basket, generally designated 12, which is used for holding food products in a food cooking apparatus, such as a deep frying apparatus having a reservoir of cooking oil. Basket 12 generally includes a wire form frame, generally designated 14, and a plurality of stackable wire form shelves, generally designated 16. A pair of stamped and formed sheet metal brackets 18 are fixed to opposite sides of the basket for facilitating lowering the basket into a reservoir of frying oil to cook the food products and to lift the basket out of the oil and allow the products to drain. As will be described in detail hereinafter, complementary inter-engaging mounting structures, generally designated 20, and including a pair of horizontally slotted sheet metal plates 22, are provided between frame 14 and shelves 16 at the rear corners of basket 12 to provide for moving the loaded onto a given shelf without interference from any shelf above the given shelf.

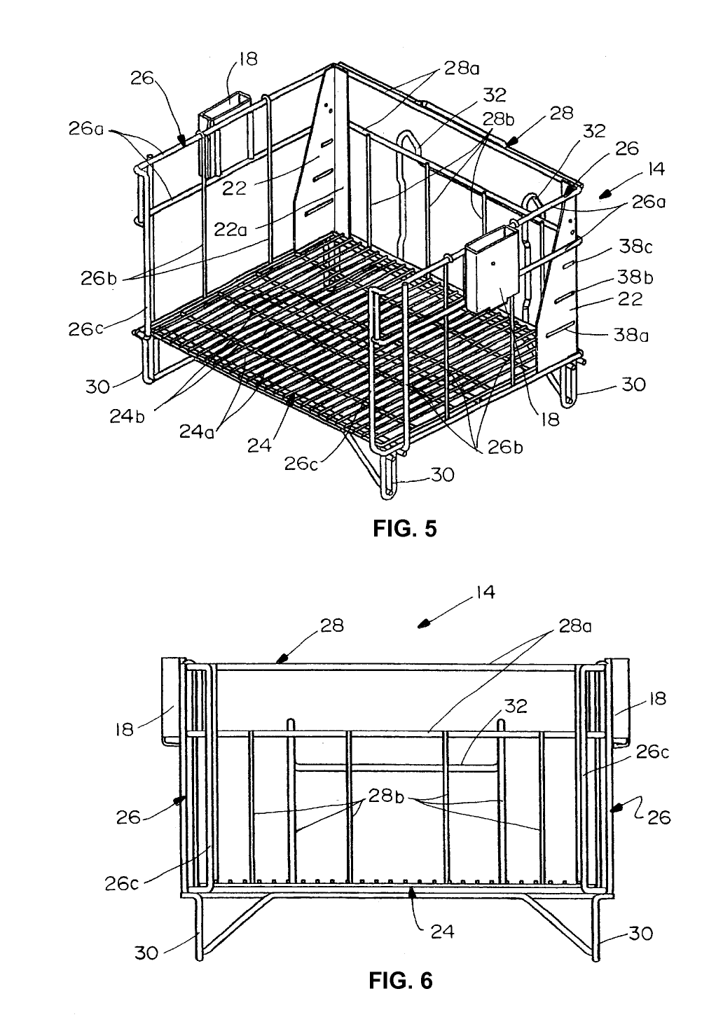

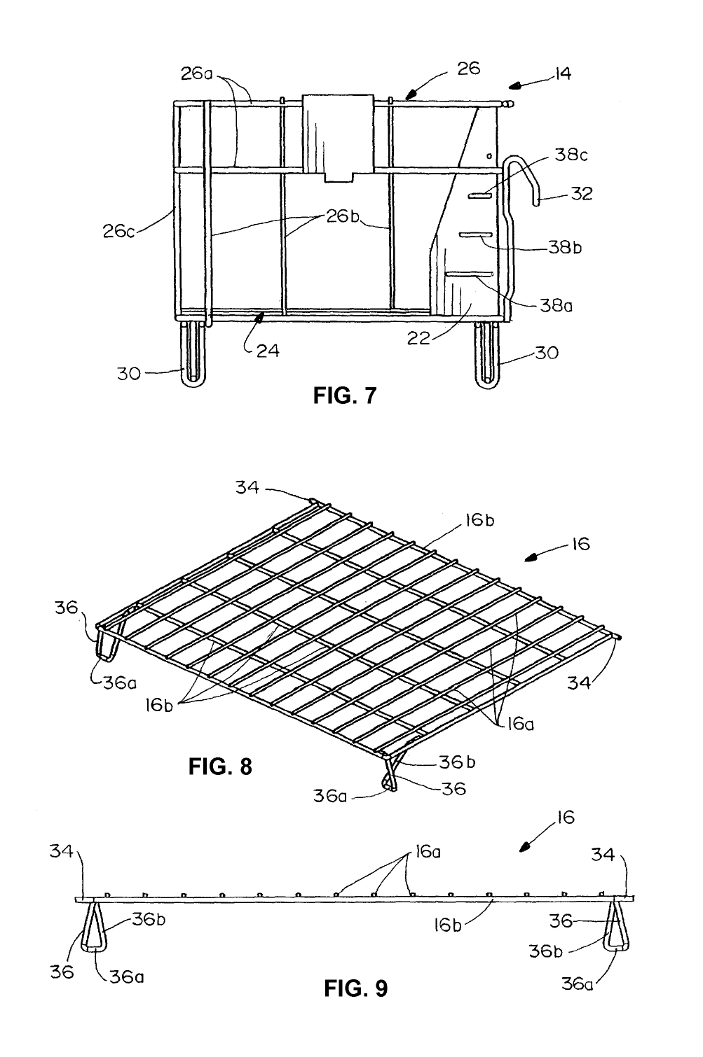

Referring to FIGS. 5-7 in conjunction with FIGS. 1-4, wire form frame 14 includes a bottom wall, generally designated 24, end side walls, generally designated 26, and a rear side wall, generally designated 28. The three side walls extend upright from the bottom wall to define an open-top/open-front structure. The bottom wall and side walls all are of wire form construction. In particular, the bottom wall includes front-to-rear wires or rods 24a joined to transverse rods 24b to form a grid which is sufficiently dense to provide a support structure on top of which food products, such as chicken filets or the like, can be arranged. End side walls 26 include horizontal rods 26a joined to vertical rods 26b. The front corners of end side walls 26 are turned inwardly to vertical rods 26c. Rear side wall 28 includes horizontal rods 28a and vertical rods 28b. Brackets 18 are fixed to the rods of end side walls 26 on the outsides thereof. Slotted plate 22 is fixed to the rods of the end side walls on the insides thereof. The slotted plates include flanges 22a which are fixed to the vertical rods of rear wall 28. In other words, the slotted plates are L-shaped in horizontal section and are fixed within the basket at the inside corners or junctures of end side walls 26 and rear side wall 28.

Still referring to FIGS. 5-7 in conjunction with FIGS. 1-4, wire form frame 14 includes four wire form legs 30 at the four corners thereof fixed to and projecting downwardly from bottom wall 24. The legs allow the basket to be supported on a surface, such as a countertop, for loading the basket with food products. A pair of wire form hooks 32 are fixed to the horizontal rods of rear wall 28 at the rear of the basket. The hooks allow the basket to be hung from an appropriate support structure above the reservoir of cooking oil so that excess oil can drain or drip from the food products as well as from the basket, itself.

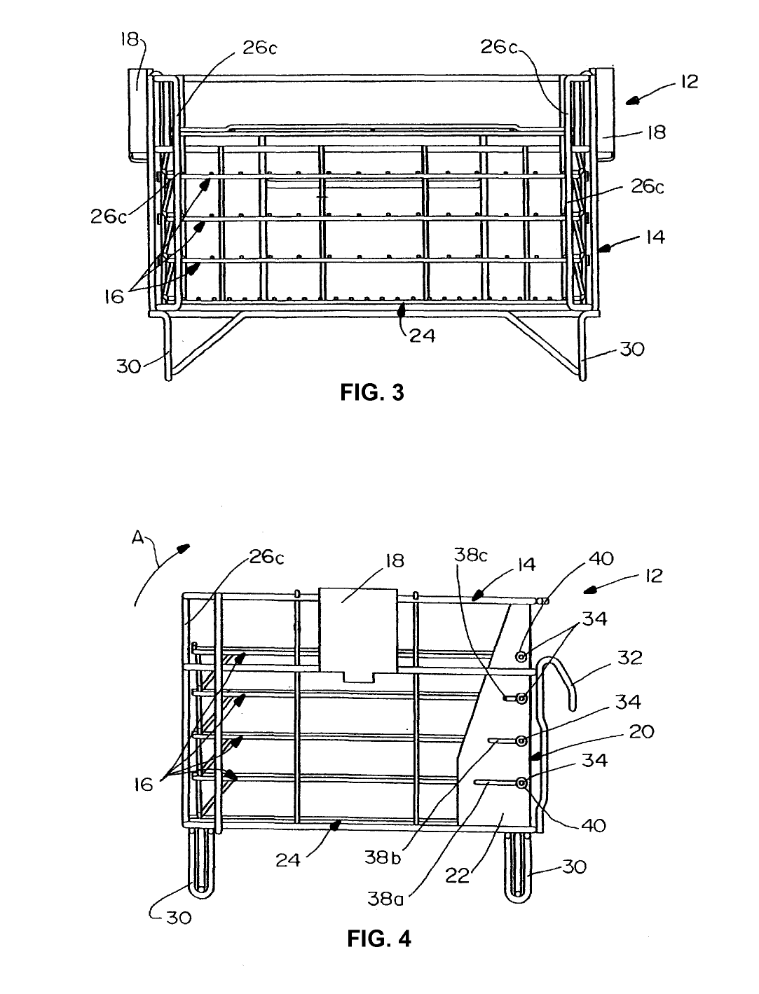

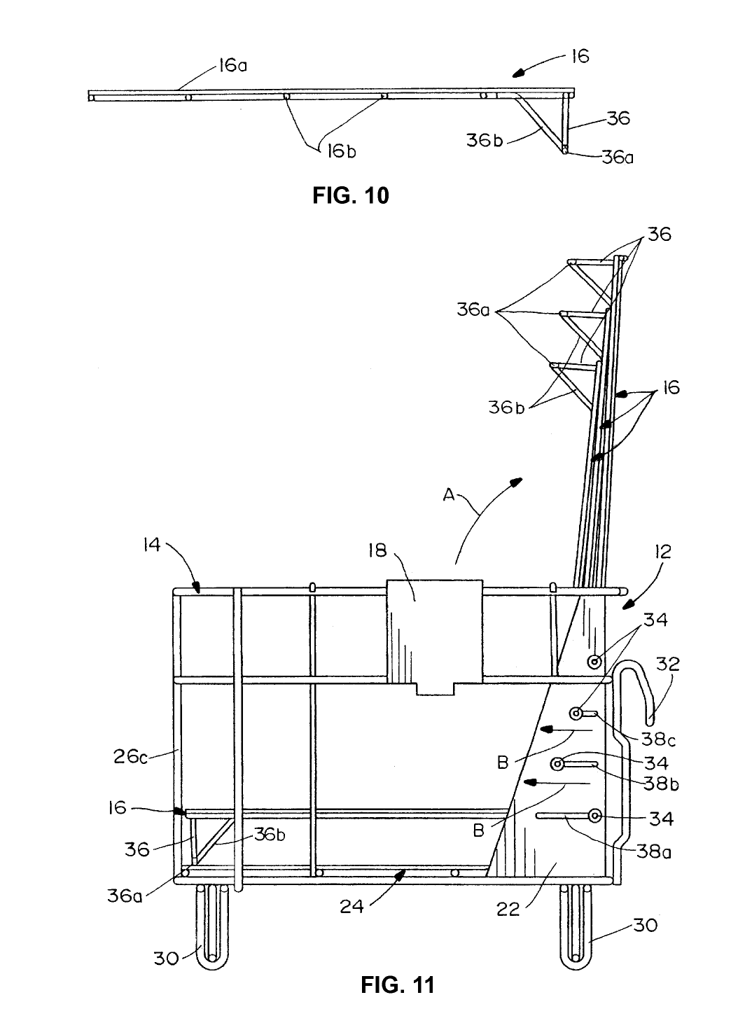

Referring to FIGS. 8-10 in conjunction with FIGS. 1-4, one of the movable shelves 16 is shown. Each shelf is of a wire form construction including a plurality of front-to-rear wires or rods 16a joined to a plurality of transverse rods 16b to form a grid upon which the food products, such as chicken filets, are arranged for frying. It should be noted that the rear-most transverse rod 16a projects beyond the sides of the shelf to form pivot pins 34. A pair of wire form legs 36 project downwardly from the front corners of the shelf and terminate in a bottom rod section defining a horizontal platform 36a. The platform is sufficiently wide so that the shelves are stackable above bottom wall 24 of wire form frame 14, with the platforms of the shelves resting either on the extreme outside front-to-rear rods 24a of the bottom wall or on the extreme outside front-to-rear rods 16a of subjacent shelves. In other words, as best seen in FIGS. 1 and 3, a bottom shelf 16 is stacked on bottom wall 24 of the wire form frame, and three additional shelves 16 are stacked on top of the bottom shelf. Each leg 36 of each shelf also has a rearward extending angled brace portion 36b which defines a ramp. It can be seen that the ramps are on the insides of the legs. Therefore, the ramps of one shelf are “engageable” or capable of being engaged, with the front edge of a subjacent shelf when the shelves move or pivot up and down as described below.

Referring back to FIG. 4, it can be seen that each slotted plate 22 has a series of horizontal slots 38a, 38b and 38c. Slot 38a is in line with the bottom shelf 16. Slot 38b is in line with the shelf immediately above the bottom shelf. Slot 38c is in line with the next stacked shelf.

Pivot pins 34 of the three lower shelves extend into slots 38a-38c, and the pivot pins for the top shelf extend into holes (not visible) in slotted plates 22. Enlargements 40 are secured to the extreme distal ends of pivot pins 34 on the outsides of the slotted plates. Therefore, the pivot pins extend through the slotted plates to provide for pivoting of shelves 16 from their food-supporting positions shown in FIG. 4, in a direction indicated by arrow “A”, upwardly to generally vertical loading positions shown in FIG. 11.

Referring specifically to FIG. 11, it can be seen that the three upper shelves 16 have been pivoted upwardly in the direction of arrow “A” to their generally vertical loading positions, while the bottom shelf 16 remains stacked and supported on top of bottom wall 24 of wire form frame 14. During this action, the very top shelf simply pivots upwardly about its pivot pins 34. However, it can be seen that pivot pins 34 of the two intermediate shelves have moved forwardly in the direction of arrows “B”, within slots 38b and 38c of slotted plate 32. This allows the rear edges of the shelves to move forwardly so that the shelves can clear the previously raised shelves. As seen clearly in FIG. 11, the slots increase in length downwardly along slotted plate 22. This increasing length is required because the lower shelves must clear more upper shelves as the shelves are progressively pivoted upwardly. In other words, the second shelf from the top must clear only the top shelf. However, the next shelf having pivot pins 34 in slots 38b must clear both of the shelves there above. Slots 38a for the bottom shelf are the longest slots, because the bottom shelf must clear all of the shelves there above.

In operation, and still referring to FIG. 11, wire form basket 12 is loaded by first pivoting all shelves 16 upwardly to their generally vertical loading positions. All of the shelves can be pivoted upwardly simply by lifting on the bottom shelf. The shelves remain in their upper or loading positions of FIG. 11, because the shelves move “over-center” the pivots thereof as defined by pins 34. This allows food products, such as chicken filets, to be easily and neatly arranged on top of bottom wall 24 of the wire form frame of the basket. After the bottom wall is loaded with the food products, the bottom shelf 16 is lowered to the position shown in FIG. 11, with platforms 36a of legs 36 of the bottom shelf resting on top of bottom wall 24. It can be seen that pivot pins 34 for the bottom shelf have been moved to the rear of slots 38a. The bottom shelf now can be easily loaded with the food products. Once the bottom shelf is loaded, the next shelf having pivot pins 34 within slots 38b is lowered or stacked onto the bottom shelf, and it is loaded with food products. This procedure is continued until all of the shelves are sequentially lowered and loaded with food products, whereupon the entire loaded basket can be lowered into the reservoir of frying oil. Without being able to pivot the shelves upwardly, it would be physically impossible to completely load the shelves with food products without having to push the food products against each other toward the rear of the shelves. This would cause disfiguration of the food products, particularly thin and soft products such as chicken filets.

While the structure described above works well to prevent damage and disfiguration of thin and soft food products such as chicken filets, it has been observed that the top shelf of the basket 12, can sometimes be damaged by unintended collisions with other objects because it is most exposed. The ability to remove and replace the top shelf is therefore desireable.

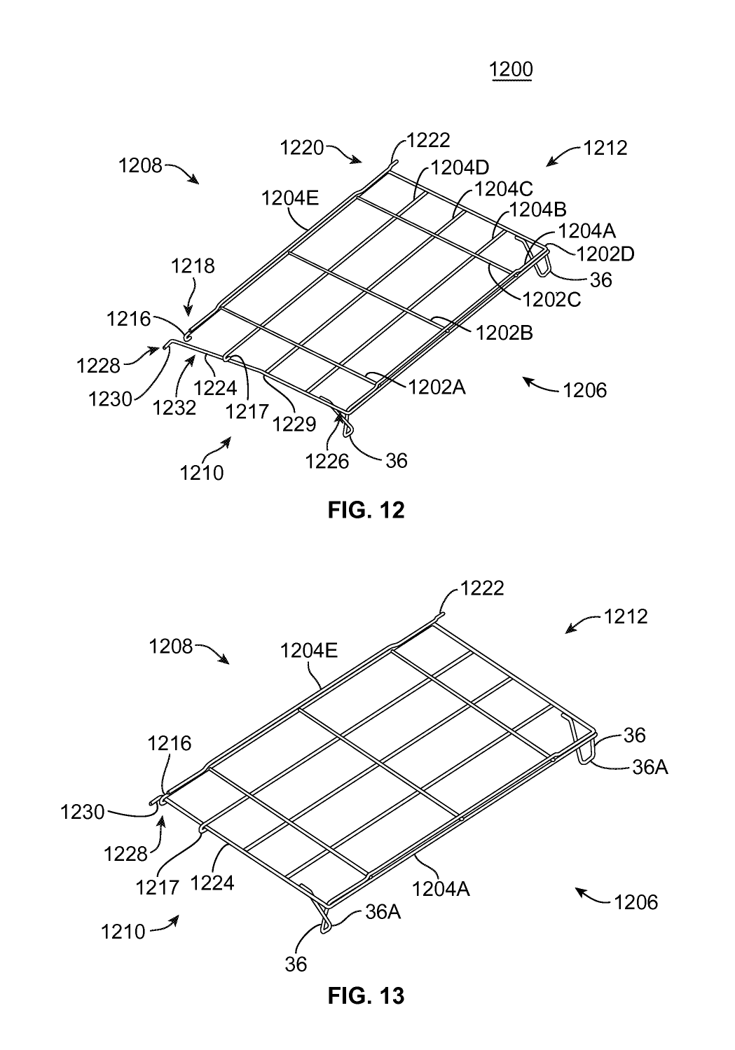

FIG. 12 is a perspective view of a removable shelf 1200, configured to be installed into and removed from the basket 12 without requiring any disassembly of the basket 12. The removable shelf 1200 can also be installed and removed without requiring tools. Installing and removing the shelf 1200 requires only deflecting one spring steel wire on one side of the shelf 1200. The shelf 1200 is thus considered to be “field replaceable.” Its replacement does not require tools or equipment but requires only squeezing or compressing the spring wire to clear the open hooks.

As with the shelves shown in the other figures and described above, the field-replaceable shelf 1200 shown in FIG. 12 is made up of several rigid wires 1202A-1202D (four shown), spaced apart and parallel to each other. The wires 1202A-1202D are attached to transverse rods 1204A-1204E, (five shown) also spaced apart and parallel to each other. The rods 1204 are considered herein to be “transverse” because they are at right angles to the wires 1202. The number of rigid wires and the number of transverse rods is a design choice.

For claim construction purposes, the shelf 1200 has a front 1206 and a rear 1208. It also has a left or “first” side 1210 and an opposing right or “second” side 1212.

One of the transverse rods, which is denominated herein as the back transverse rod 1204E, is located at and defines the rear 1208 of the shelf 1200. The back transverse rod 1204E has an open hook 1216 formed at its left-side end 1218. The back transverse rod 1204E has at its right-side end 1220, a relatively short portion 1222, which extends outwardly past the right-side 1212 of the shelf 1200 and which acts as a pivot pin, also referred to herein as the right-side pivot pin 1222. Pivot pins are described above and identified in FIGS. 1-11 by reference numeral 34. An intermediate transverse rod 1204D also has an open hook 1217 at its left-side end.

Referring now to the left or first side 1210 of the shelf 1200, a pre-determined length of spring-steel wire 1224 has first and second opposing ends, 1226 and 1228 respectively. The spring-steel wire 1224 is attached to the left end of three transverse rods 1204A, 1204B and 1204C, preferably by welding, but unattached to the two rear transverse rods 1204D and 1204E. The attachment of the spring-steel wire 1224 at one end 1226 but not the other 1228 thus causes the spring-steel wire to behave or act as a cantilever spring having a fulcrum 1229 located where the spring-steel wire 1224 is attached to “intermediate” transverse rod 1204C.

In a preferred embodiment, the spring-steel wire 1224 is shaped and arranged such that when it is not compressed, it extends laterally away from the left side 1210 of the shelf. As shown in FIG. 12, the deflection away from the left side 1210 begins at about the location of the fulcrum 1229. The shape of an uncompressed spring steel wire will depend on factors that include the wire's elastic modulus. In an alternate embodiment, the spring steel wire can be normally straight and require an “inward” deflection.

The second end 1228 of the spring-steel wire 1224 is formed to have, or is otherwise provided with a relatively short, transverse projection part 1230, which extends away from the first side 1210 of the shelf 1200. The projection part 1230 thus causes the second end 1228 to have a shape substantially the same as the letter “L.”

In the preferred embodiment, which uses a spring steel wire that extends away from the side of the shelf, 1200, the spring-steel wire is formed of a material and is sized, shaped and arranged to permit the cantilevered portion of the spring 1232 beyond the fulcrum 1229 to be “compressed” by hand in order to urge the cantilevered portion 1232 toward the right side 1212 of the shelf by hand. When the cantilevered portion 1232 is compressed so that it's second end 1228 is just inside the left side 1210 of the shelf 1200 and the second end 1228 is just to the “right” side of the open hook 1216, the cantilevered portion 1232 of the spring-steel wire 1224 can be “lifted” upwardly and the compressing force released, allowing the mechanical force stored in the spring-steel wire 1224 to maintain the engagement of the second end 1228 in the open hook 1216. Stated another way, compressing the spring-steel wire 1224 and moving its second end 1228 into the open hook essentially “captures” the second end 128 in the hook. The mechanical force stored in the spring-steel wire 1224 keeps the wire 1224 engaged with the hook 1216 until the spring-steel wire 1224 is compressed toward the right-side of the shelf 1200 and urged downwardly below the hook 1216.

FIG. 13 is a perspective view of the removable shelf 1200 with the spring-steel wire 1224 compressed and its second end 1228 captured in the hook 1216. Those of ordinary skill in the art should recognize that when the spring-steel wire 1224 is engaged in the hook 1216, the transverse projection 1230 at the second end 1228 of the wire 1224 becomes a pivot pin for the shelf 1200, as is the pivot pin 1222 located at the opposite, right-side end 1220 of the back transverse rod 1204E. The transverse projection 1230 can thus engage one of the horizontal slots 38a-38c (See FIG. 5.) in one of the metal plates 22 thereby enabling the shelf 1200 to function in the frame 14, the same way that the shelves described above function except that the shelf 1200 shown in FIG. 12 can be installed and removed in any of the slots 38a-38c, at any time, without tools or special equipment.

Installation of the shelf 1200 into a wire form frame 14 is straight forward due in part to the spring-steel wire 1224 being configured to be easily compressed by hand.

FIG. 13 is a perspective view of the removable shelf 1200 with the spring-steel wire 1224 compressed and its second end 1228 captured in the hook 1216. Those of ordinary skill in the art should recognize that when the spring-steel wire 1224 is engaged in the hook 1216, the transverse projection 1230 at the second end 1228 of the wire 1224 becomes a pivot pin for the shelf 1200, as is the pivot pin 1222 located at the opposite, right-side end 1220 of the back transverse rod 1204E. The transverse projection 1230 can thus engage one of the horizontal slots 38a-38c in one of the metal plates 22 thereby enabling the shelf 1200 to function in the frame, the same way that the shelve described above function except that the shelf 1200 shown in FIG. 12 can be installed and removed without tools or special equipment.

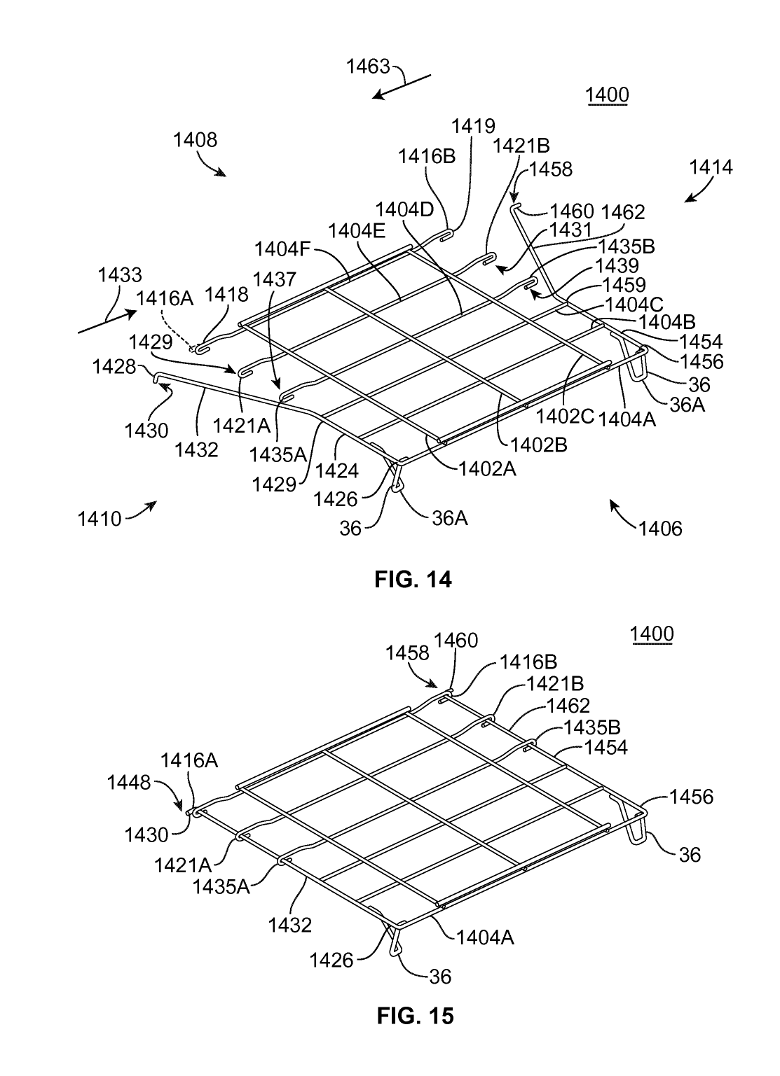

FIG. 14 is a perspective view of an alternate embodiment of a removable shelf 1400, also configured to be installed into and removed from the basket 12 without requiring any disassembly of the basket 12. The removable shelf 1400 can also be installed and removed without requiring tools. Installing and removing the shelf 1400 requires only deflecting one or both spring steel wires on opposite sides of the shelf 1400. The shelf 1400 is thus also considered to be “field replaceable,” i.e., it does not require tools or special equipment but is simply removed and replaced by squeezing the spring wires.

As with the shelves shown in the other figures and described above, the field-replaceable shelf 1400 shown in FIG. 14 is made up of several rigid wires 1402A-1402C spaced apart and parallel to each other. The wires 1402A-1202C are attached to transverse rods 1404A-1404F, (six shown) also spaced apart and parallel to each other. The rods 1404 are considered herein to be “transverse” because they are at right angles to the wires 1402.

For claim construction purposes, the shelf 1400 has a front 1406 and a rear 1408. It also has a left or “first” side 1410 and an opposing right or “second” side 1414.

As with the replaceable shelf 1200 shown in FIG. 12, one of the transverse rods 1404F is denominated herein as the back transverse rod. It is located at and defines the rear 1408 of the shelf 1400.

The back transverse rod 1404F has an open hook 1416A formed at its left-side end 1418. Unlike the back transverse rod 1204E shown in FIG. 12, the back transverse rod 1404F also has an open hook 1416B formed at its right-side end 1419. The back transverse rod 1404F thus has open hooks 1416A, 1416B at both ends 1418, 1419.

Two intermediate rods 1404E and 1404F also have open hooks at their left and right ends. As can be seen in FIG. 14, a first intermediate rod 1404E has open hooks 1421A, 1421B at its opposite ends 1429, 1431. A second intermediate rod 1404D has open hooks 1435A, 1435B at its opposite ends 1437, 1439.

Referring now to the left or first side 1410 of the shelf 1400, a pre-determined length of spring-steel wire 1424 has first and second opposing ends, 1426 and 1428 respectively. The spring-steel wire 1424 is attached to the left end of three transverse rods 1404A, 1404B and 1404C but is unattached to the two intermediate transverse rods 1404D and 1404E and unattached to the rear transverse rod 1404F. The attachment of the spring-steel wire 1424 at one end 1426 but not the other 1428 thus causes the spring-steel wire to behave or act as a cantilever spring having a fulcrum 1429 located where the spring-steel wire 1424 is attached to “intermediate” transverse rod 1404C.

The spring-steel wire 1424 is shaped and arranged such that it extends laterally away from the left side 1410 of the shelf. The deflection away from the left side 1410 begins at about the location of the fulcrum 1429.

The second end 1428 of the spring-steel wire 1424 is formed to have, or is otherwise provided with a relatively short, transverse projection part 1430, which extends in a direction that is away from the first side 1410 of the shelf 1400. The projection part 1430 thus causes the second end 1428 to have a shape substantially the same as the Arabic letter “L.”

The spring-steel wire 1424 is formed of a material and is sized, shaped and arranged to permit the cantilevered portion of the spring 1432 beyond the fulcrum 1429 to be “compressed” by hand in order to urge the cantilevered portion 1432 in a direction 1433 that is toward the right side 1414 of the shelf. When the cantilevered portion 1432 is compressed so that it's second end 1428 is just inside the left side 1410 of the shelf 1200 and the second end 1428 and cantilevered portion 1432 are just to the “right” side of the open hooks 1416A, 1421A, 1435A, the cantilevered portion 1432 of the spring-steel wire 1224 can be “lifted” upwardly and the compressing force released, allowing the mechanical force stored in the spring-steel wire 1424 to maintain the engagement of the second end 1428 in the open hook 1416 as well as maintain the engagement of the cantilevered portion 1432 in the open hooks 1421A and 1434A of the intermediate transverse rods 1404E and 1404D. Stated another way, compressing the spring-steel wire 1424 and moving its second end 1428 and cantilevered portion 1432 into the open hooks essentially “captures” the second end 1428 and cantilevered portion in the open hooks. Mechanical force stored in the spring-steel wire 1424 keeps the wire 1424 engaged with the hooks until the spring-steel wire 1424 is compressed toward the right-side of the shelf 1400 and urged downwardly below the hook 1416.

Still referring to FIG. 14, the right side 1414 of the shelf 1400 is provided with a second spring steel wire a pre-determined length of spring-steel wire 1454 has first and second opposing ends, 1456 and 1458 respectively. The spring-steel wire 1454 is attached to the right ends of three transverse rods 1404A, 1404B and 1404C but is unattached to the right ends of two intermediate transverse rods 1404D and 1404E. It is also unattached to the rear transverse rod 1404F. The attachment of the spring-steel wire 1454 at its one end 1456 but not its other 1458 thus causes the spring-steel wire 1454 to behave or act as a cantilever spring having a fulcrum 1459 located where the spring-steel wire 1454 is attached to the right end of the “intermediate” transverse rod 1404C.

Similar to the first spring-steel wire 1424 on the left side, the second spring steel wire 1454 is shaped and arranged such that it extends laterally away from the right side 1414 of the shelf 1400. The deflection of the second spring steel wire 1454 away from the right side 1414 begins at about the location of the fulcrum 1459.

The second end 1458 of the spring-steel wire 1454 is formed to have, or is otherwise provided with a relatively short, transverse projection part 1460, which extends in a direction that is away from the right side 1414 of the shelf 1400. The right-side projection part 1460 thus causes the second end 1458 to have a shape substantially the same as the letter “L.”

The spring-steel wire 1454 is formed of a material and is sized, shaped and arranged to permit the cantilevered portion of the spring 1462 beyond the fulcrum 1459 to be “compressed” by hand in order to urge the cantilevered portion 1462 in a direction 1463 that is toward the left side 1410 of the shelf 1400. When the cantilevered portion 1462 is compressed so that it's second end 1488 is just inside the right side 1414 of the shelf 1400 and the second end 1458 and cantilevered portion 1462 are just to the “left” side of the open hooks 1416B, 1421B, 1435B, the cantilevered portion 1462 of the spring-steel wire 1454 can be “lifted” upwardly and the compressing force released, allowing the mechanical force stored in the spring-steel wire 1454 to maintain the engagement of the second end 1458 in the open hook 1416B as well as maintain the engagement of the cantilevered portion 1462 in the open hooks 1421B and 1434B of the intermediate transverse rods 1404E and 1404D. Stated another way, compressing the spring-steel wire 1454 and moving its second end 1458 and cantilevered portion 1462 into the open hooks essentially “captures” the second end 1458 and cantilevered portion in the open hooks. Mechanical force stored in the spring-steel wire 1454 keeps the wire 1454 engaged with the hooks until the spring-steel wire 1454 is compressed toward the right-side of the shelf 1400 and urged downwardly below the hook 1416A.

FIG. 15 is a perspective view of the removable shelf 1400 with the left-side spring-steel wire 1424 compressed. Its second end 1428 and cantilever portion 1432 are captured into the left-side open hooks 1416A, 1421A and 1435A. The right-side spring-steel wire 1454 is also compressed. Its second end 1458 and its cantilever portion 1462 are captured in the right-side open hooks 1416B, 1421B and 1435B.

Those of ordinary skill in the art should recognize that when the spring-steel wires 1424 and 1454 are engaged in the hooks, the transverse projections 1430 and 1460 at the second ends 1428 and 1458 become pivot pins for the shelf 1400. The transverse projections 1430 and 1460 can thus engage one of the horizontal slots 38a-38c in one of the metal plates 22 thereby enabling the shelf 1400 to function in the frame, in the same way that the shelves described above function except that the shelf 1400 shown in FIGS. 14 and 15 can be installed and removed without tools or special equipment.

Those of ordinary skill in the art will recognize that when the spring-steel wires 1424 and 1454 are sufficiently compressed such that the transverse projections 1430 and 1460 are fully inside the left and right sides of the shelf 1400, rotating the shelf, i.e., lifting either the left side 1410 of a shelf or the right side 1414 upwardly, relative to the other side enables the “lower” side of the shelf 1400 to be placed into the wire form frame 14 and enables the pivot pins 1418, 1419 to be placed inside one of the horizontal slots 38a-38c. Shelf removal is a straight-forward process, accomplished by simply reversing the process described above.

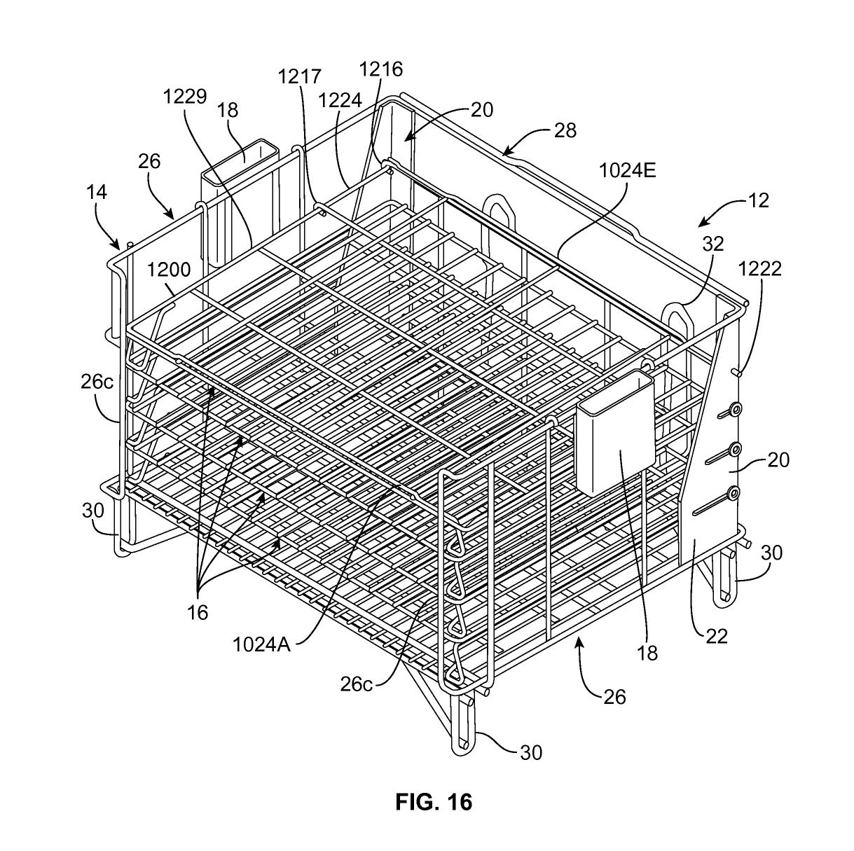

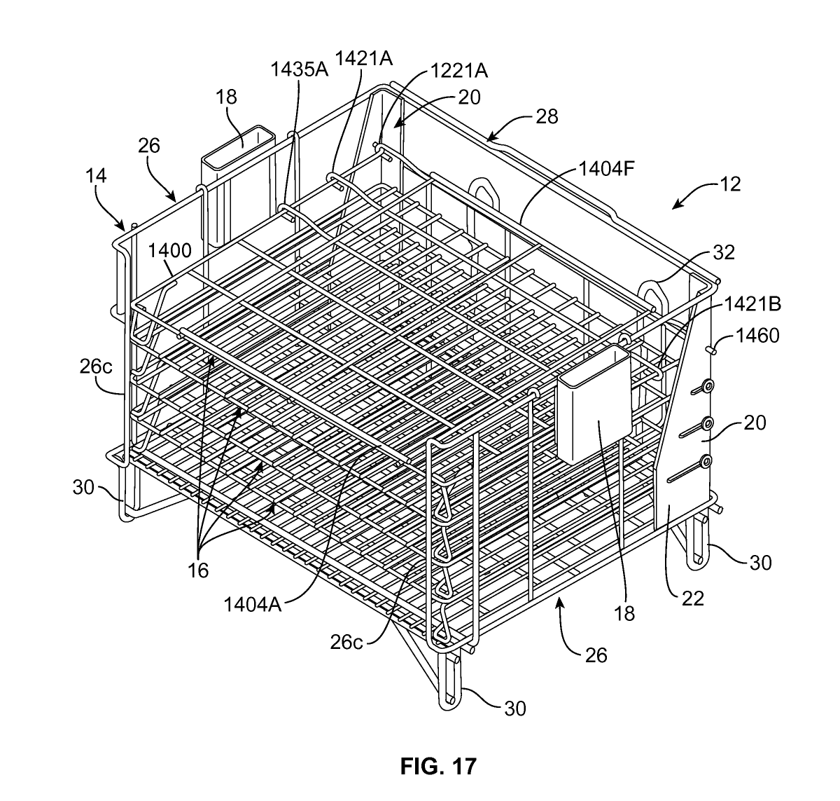

FIG. 16 is a perspective view of the food cooking basket 12 of FIG. 1, the top shelf 1200 of which is made field-replaceable using the shelf shown in FIGS. 12 and 13. FIG. 17 is a perspective view of the food cooking basket 12 of FIG. 1, the top shelf 1400 of which is made field-replaceable using the shelf shown in FIGS. 14 and 15. The baskets 12 shown in FIGS. 16 and 17 thus retain all of the functionality of the basket shown in FIG. 1 but they include a top shelf that is field-replaceable.

It should be noted that legs 36, including platforms 36a, have vertical lengths to space shelves 16 and 1200 relative to each other and relative to bottom wall 24 so that the food products do not unnecessarily curl during cooking. For chicken filets, for instance, the spacing may be on the order of 1.25 inches between the shelves to prevent unnecessary curling of the filets. Therefore, such filets may not be positioned on the top shelf, and the top shelf may be provided simply as a hold-down structure, with the filets being loaded on bottom wall 24 of the wire frame and only on the three lower shelves.

The spring steel wire is ASTM-A227 hard-drawn spring wire. Contrary to conventional practice in the mechanical art, the spring steel spring wire located between at or between the fulcrum and front of the shelf 1200, 1400 is spot welded to rigid wires that are made of CRS-C1008 cold rolled steel. The transverse rods are also made of CRS-C1008 cold rolled steel. The localized nature of the spot weld is such that it does not appreciably weaken the spring steel wire. Alternate embodiments include brazing the steel wire to the cold rolled steel.

The examples and embodiments described above are for purposes of illustration. The true scope of the invention is set forth in the following claims.

What is claimed is:

1. A field-replaceable shelf for a wire form basket, the shelf comprising:
a first transverse rod at a back side of the shelf, the first transverse rod formed to have an open hook at a first end, the shelf also having a first spring wire located at a first side of the shelf, the first spring wire having a first end attached to a transverse rod located at a front side of the shelf, the first spring wire also having an opposing, unattached and cantilever second end proximate the first transverse rod whereat a transverse projection of the first spring wire extends laterally in a direction that is at least substantially away the first side.

2. The field-replaceable shelf of claim 1, wherein the first transverse rod at a back side of the shelf is formed to have an open hook at an opposing second end, the shelf also having a second spring wire located at a second side of the shelf, the second spring wire having a first end attached to the transverse rod located at a front side of the shelf, the second spring wire also having an opposing, unattached and cantilevered second end proximate the second end of the first transverse rod whereat a transverse projection of the second spring wire extends laterally in a direction that is at least substantially away the second side.

3. A wire form basket for holding food products in a deep frying apparatus, the basket comprising:
a wire form frame comprising first and second opposing side walls, which are separated from each other, defining an open space between them;
a first sheet metal plate coupled to the first opposing side wall, the first sheet metal plate having a plurality of substantially horizontal slots, the plurality of substantially horizontal slots being vertically separated from each other;
a second sheet metal plate coupled to the second opposing side wall and located across the open space from the first sheet metal plate, the second sheet metal plate having a plurality of substantially horizontal slots, the plurality of substantially horizontal slots in the second sheet metal plate being vertically separated from each other, vertical separations of the slots in the first sheet metal plate being substantially the same as vertical separations of the slots in the second sheet metal plate;
a plurality of generally horizontal food-supporting shelves vertically stackable in said space between the first and second opposing side walls, with one shelf above another shelf, each shelf comprising a plurality of space-apart wires extending between a front and back of each shelf, the spaced apart wires joined to a plurality of transverse rods extending between first and second sides of each shelf, the transverse wires having a first end at the first side and a second end at the second side, a transverse wire located at the back of each shelf having at least a second end that extends past the second side and which comprises a pivot pin that projects into a corresponding horizontal slot in a sheet metal plate;
a first shelf of the plurality of generally horizontal food supporting shelves having a first transverse rod at the back of the first shelf, the first transverse rod formed to have an open hook at its first end, the first shelf also having a first spring wire located at its first side, the first spring wire having a first end attached to a transverse rod located at the front of the first shelf and an opposing, unattached second end proximate the first transverse rod whereat a transverse projection extends laterally in a direction that is at least substantially away the first side, the transverse projection being sized, shaped and arranged, such that when the first spring wire is deflected toward the second side, the spring wire moved inside the open hook and then released, the spring transverse projection provides a first pivot pin for the first shelf, tension in the spring wire causing the transverse projection to maintain its engagement with a first horizontal slot.

3. The wire form basket of claim 2, wherein said spring wire comprises a cantilever spring.

4. The wire form basket of claim 3, wherein the cantilever spring has a fulcrum located between the front and rear of the shelf.

5. The wire form basket of claim 2 wherein said first shelf has a second pivot pin that extends away from the second end of the first transverse rod.

6. The wire form basket of claim 3 wherein said first pivot pin and the second pivot pin are configured to enable the first shelf to pivot between an upright position and a horizontal position.

7. The wire form basket of claim 6 wherein said cantilever spring is configured to be compressed such that the first pivot pin is removable from the first horizontal slot by deflection of the spring wire toward the second side, the first shelf being additionally configured to be removed when the first spring wire is deflected toward the second side.

8. The wire form basket of claim 2 wherein pivot pins on a plurality of shelves extend into a corresponding plurality of horizontal slots on a side wall of the frame.

9. A wire form basket for holding food products in a deep frying apparatus, the basket comprising:
a wire form frame comprising first and second opposing side walls, which are separated from each other, defining an open space between them;
a first sheet metal plate coupled to the first opposing side wall, the first sheet metal plate having a plurality of substantially horizontal slots, the plurality of substantially horizontal slots being vertically separated from each other;
a second sheet metal plate coupled to the second opposing side wall and located across the open space from the first sheet metal plate, the second sheet metal plate having a plurality of substantially horizontal slots, the plurality of substantially horizontal slots in the second sheet metal plate being vertically separated from each other, vertical separations of the slots in the first sheet metal plate being substantially the same as vertical separations of the slots in the second sheet metal plate;
a plurality of generally horizontal food-supporting shelves vertically stackable in said space between the first and second opposing side walls, with one shelf above another shelf, each shelf comprising a plurality of space-apart wires extending between a front and back of each shelf, the spaced apart wires joined to a plurality of transverse rods extending between first and second sides of each shelf, the transverse wires having a first end at the first side and a second end at the second side, a transverse wire located at the back of each shelf having at least a second end that extends past the second side and which comprises a pivot pin that projects into a corresponding horizontal slot in a sheet metal plate;
a first shelf of the plurality of generally horizontal food supporting shelves having a first transverse rod at the back of the first shelf, the first transverse rod formed to have an open hook at opposing first and second ends, the first shelf comprising:
a first spring wire located at its first side, the first spring wire having a first end attached to a transverse rod located at the front of the first shelf and an opposing, unattached second end proximate the first end of the first transverse rod whereat a first transverse projection extends laterally in a direction that is at least substantially away the first side; and
a second spring wire located at its second side, the second spring wire having a first end attached to a transverse rod located at the front of the first shelf and an opposing, unattached second end proximate the second of the first transverse rod whereat a second transverse projection extends laterally in a direction that is at least substantially away the first side;
the first and second transverse projections being sized, shaped and arranged, such that when the first and second spring wires are deflected toward each other and moved inside the open hooks at the opposing first and second ends of the first transverse rod, the transverse projections provide first and second pivot pins for the first shelf, tension in the spring wires causing the transverse projections to maintain its engagement with horizontal slots/

10. The wire form basket of claim 9, wherein said spring wires comprise cantilever springs.

11. The wire form basket of claim 10, wherein the cantilever springs have fulcrums located between the front and rear of the shelf.

12. The wire form basket of claim 9 wherein said first and second pivot pins are configured to enable the first shelf to pivot between an upright position and a horizontal position.
